(19) United States
(12) Patent Application Publication
(10) Pub. No.: US 2006/0038744 A1
(43) Pub. Date: Feb. 23, 2006

(54) Display control apparatus and method, and program

(76) Inventor: Yuji Ishimura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/204,034

(22) Filed: Aug. 16, 2005

(30) Foreign Application Priority Data
Aug. 18, 2004 (JP) 2004-237904

(51) Int. Cl. G09G 1/06

(52) U.S. Cl. 345/10

(57) ABSTRACT

Disclosed herein is a display control apparatus for updating a display state of an object for movement with a predetermined period. The display control apparatus includes: a setting section for setting a final state as a final target display state of the object; a calculation section for calculating an update amount of display state at next update timing from a different between the final state set by the setting section and a current state as a current display state of the object; and an update section for updating the display state of the object based on the update amount of display state calculated by the calculation section.

### CROSS REFERENCES TO RELATED APPLICATIONS

The present invention contains subject matter related to Japanese Patent Application JP 2004-237904 filed in the Japanese Patent Office on Aug. 18, 2004, the entire contents of which being incorporated herein by reference.

### BACKGROUND OF THE INVENTION

The present invention relates to display control apparatus and method, and a program, and more particularly to display control apparatus and method, and a program which enable the movement of a display state of an object to be efficiently performed.

In a graphical user interface (GUI) based on software, a technique is known as an animation technique for performing the smooth movement of a certain object from a current display state to a desired display state. The technique is such that after animations until desired display states are reached are obtained in a time series order, they are compared with one another, and interpolation animations for smoothing connection among the animations are generated as necessary, and the animations are composed with the interpolation animations, thereby realizing the smooth movement (see Japanese Patent Laid-open No. 2002-109565, for example).

However, in case of the animation technique as described above, before the animations are started to be displayed, it is necessary to obtain the animations until the desired display states are reached. In addition, it is also necessary to generate the interpolation animations. As a result, there is encountered the problem that it takes time to generate a program for realizing the animations, and thus the mounting cost increases.

In addition, even when that program is actually run by a computer, the calculations for obtaining the animations and for generating the interpolation animations are required. Thus, there is also encountered the problem that the calculation cost in running the program also increases.

Moreover, there arises the program that after those calculations are made and once the animations are started to be displayed, even when a user performs another operation in the movement process until the desired display state is reached, and there occurs the necessity of moving a display state of an object to a target display state different therefrom in which the object is intended to be moved now, the object cannot be moved to a display state corresponding to the user's operation until the object is formerly moved to the target display state.

Specifically, when in a state in which a cursor is displayed on a first icon of a plurality of arranged icons, for example, a button for moving the cursor to a right-hand side is operated only once while the display state is moved so that because of only one operation of a button for moving the cursor to a left-hand side, the cursor is displayed on a second icon on the left relative to the first icon, the animation of the cursor is made so that after the cursor is moved to the second icon on the left relative to the first icon once, the cursor is moved to the first icon on the right relative to the second icon. As a result, a slight time difference occurs between the user's operation and the cursor display corresponding to the user's operation. Thus, the operation feeling is impaired.

### SUMMARY OF THE INVENTION

The present invention, for example, enables a display state of an object to be efficiently moved while a comfortable operation feeling is ensured.

According to an embodiment of the present invention, there is provided a display control apparatus for updating a display state of an object for movement with a predetermined period. The display control apparatus includes: a setting section for setting a final state as a final target display state of the object; a calculation section for calculating an update amount of display state at next update timing from a different between the final state set by the setting section and a current state as a current display state of the object; and an update section for updating the display state of the object based on the update amount of display state calculated by the calculation section.

The setting section can set the display state displayed based on at least any one of a position, a color, an angle of rotation, and a size as the final state.

The setting section can set the final state on each object becoming an update object of the display state in accordance with a user's operation.

When a user's operation for setting another final state as a target is performed after the update section starts the update of the display state of the object, the setting section can set the another final state as a display state as a new target of the object in accordance with the user's operation, and the calculation section can calculate an update amount from a difference between a current state and the another final state with the display state of the object when the user's operation is performed as the current state.

The display control apparatus may further include a determination section for determining whether or not the final state is previously set (registered) when the setting section sets the final state, and where the determination section determines that the final state is previously set, the calculation section can calculate an update amount of display state at next update timing from a difference between the previously set final state and a current state as a current display state of the object.

According to another embodiment of the present invention, there is provided a display control method for use in a display control apparatus for updating a display state of an object for movement with a predetermined period. The display control method includes the steps of: setting a final state as a final target display state of the object; calculating an update amount of display state at next update timing from a different between the final state set through the processing in the setting step and a current state as a current display state of the object; and updating the display state of the object based on the update amount of display state calculated through the processing in the calculation step.

According to still another embodiment of the present invention, there is provided a program for instructing a computer to execute a processing for updating a display state of an object for movement with a predetermined period. The program includes the steps of: setting a final state as a final target display state of the object; calculating an update amount of display state at next update timing from a different between the final state set through the processing in the setting step and a current state as a current display state of the object; and updating the display state of the object based on the update amount of display state calculated through the processing in the calculation step.

In the display control apparatus and method, and the program of the present invention, the final state as the display state as the final target of the object is set, and the update amount of display state at the next update timing is calculated from the difference between the set final state and the current state as the current display state of the object. In addition, the display state of the object is updated based on the calculated update amount.

According to the present invention, the display state of the object can be efficiently moved.

### BRIEF DRESCRIPTION OF THE DRAWINGS

FIG. 1 is a block diagram showing an example of a configuration of a display control apparatus to which the present invention is applied;

FIG. 2 is a diagram showing an example of an animation;

FIG. 3 is a block diagram showing an example of a functional configuration of the display control apparatus;

FIG. 4 is a diagram showing an example of a list in a final state;

FIG. 5 is a diagram showing an example of state movement of a final state holding block;

FIG. 6 is a diagram showing an example of a flow of signals among blocks shown in FIG. 3, and processing by the blocks;

FIG. 7 is a diagram showing another example of a flow of signals among the blocks shown in FIG. 3, and the processing by the blocks;

FIG. 8 is a flow chart explaining display control processing in the display control apparatus;

FIG. 9 is a flow chart explaining final state setting processing executed in step 1 of FIG. 8; and

FIG. 10 is a flow chart explaining state update processing executed in step 2 of FIG. 8.

### DETAILED DESCRIPTION OF THE PREFERRED EMBODIMENTS

While preferred embodiments of the present invention will be described, a correspondence relationship between the present invention described herein and the preferred embodiments of the present invention is exemplified as follows. This description is given for the purpose of verifying that the preferred embodiments for supporting the present invention described in claims are described herein. Thus, even when there is an embodiment which is described in the preferred embodiments of the present invention, but is not described herein so as to correspond to the present invention, this does not mean that that embodiment does not correspond to the present invention. Conversely, even when an embodiment is described herein so as to correspond to the present invention, this does not mean that that embodiment does not correspond to the invention other than the present invention.

Moreover, this description does not mean all the inventions described herein. In other words, this description does not deny the presence of the invention that is described herein, but is not claimed in the application, i.e., the presence of the invention that will be filed as the divisional application in the future or will be added through the amendment.

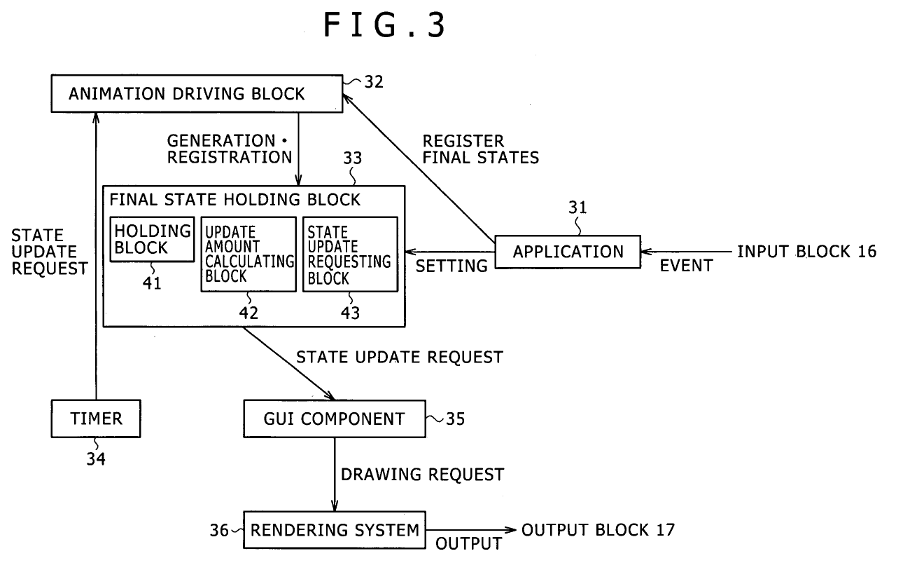

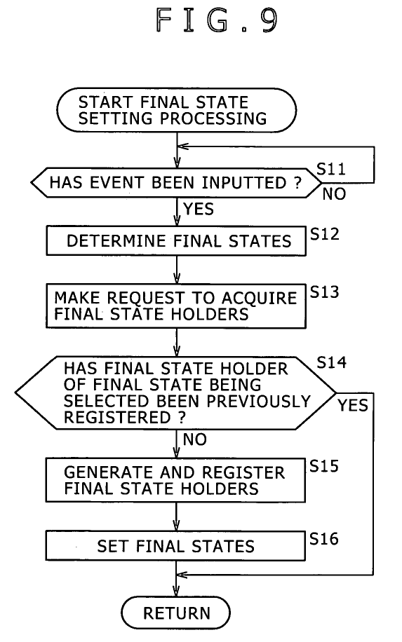

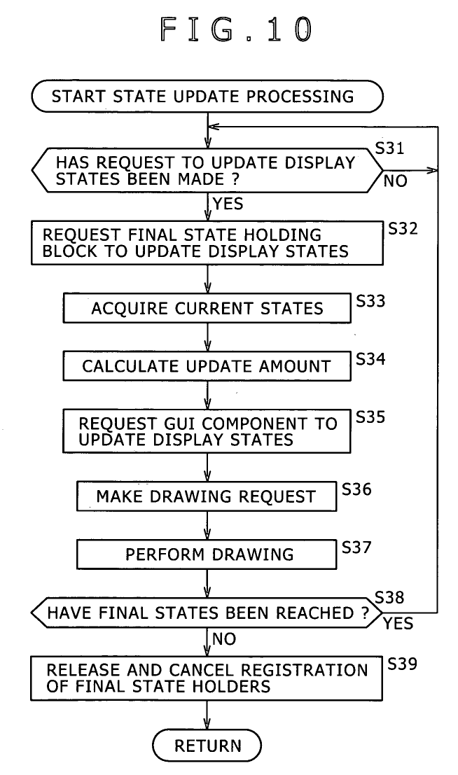

According to an embodiment of the present invention, a display control apparatus for updating a display state of an object for movement with a predetermined period includes: a setting section for setting a final state as a final target display state of the object (e.g., an application 31 of FIG. 3 for executing processing in step S16 of FIG. 9); a calculation section for calculating an update amount of display state at next update timing from a difference between the final state set by the setting section and a current state as a current display state of the object (e.g., an update amount calculating block 42 of FIG. 3 for executing processing in step S34 of FIG. 10); and an update section for updating a display state of the object based on the update amount calculated by the calculation section (e.g., a state update requesting block 43 of FIG. 3 for executing processing in step S35 of FIG. 10).

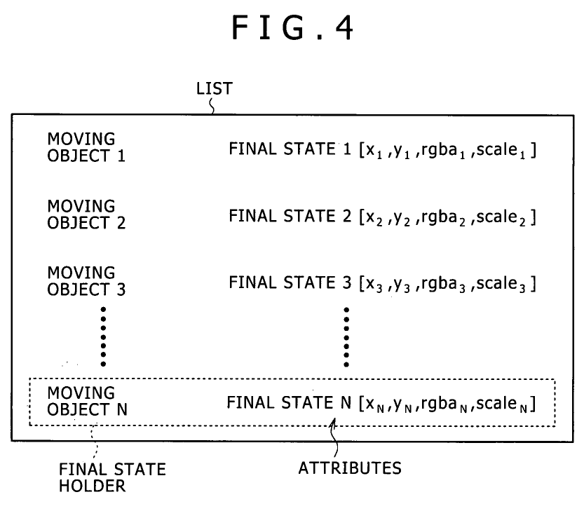

According to the embodiment of the present invention, the setting section of the display control apparatus sets the display state displayed based on at least any one of a position (e.g., attribute values xN and yN of FIG. 4), a color (e.g., an attribute value rgbaN of FIG. 4), and a size (e.g., an attribute value scale N of FIG. 4) as the final state.

According to another embodiment of the present invention, a display control method for use in a display control apparatus for updating a display state of an object for movement with a predetermined period includes the steps of: setting a final state as a final target display state of the object (e.g., step S16 of FIG. 9); calculating an update amount of display state at next update timing from a different between the final state set through the processing in the setting step and a current state as a current display state of the object (e.g., step S34 of FIG. 10); and updating the display state of the object based on the update amount of display state calculated through the processing in the calculation step (e.g., step S35 of FIG. 10).

In a program according to still another embodiment of the present invention, steps in the still another embodiment (which is merely an example) are the same as those in the display control method according to the another embodiment of the present invention.

The preferred embodiments of the present invention will hereinafter be described with reference to the accompanying drawings.

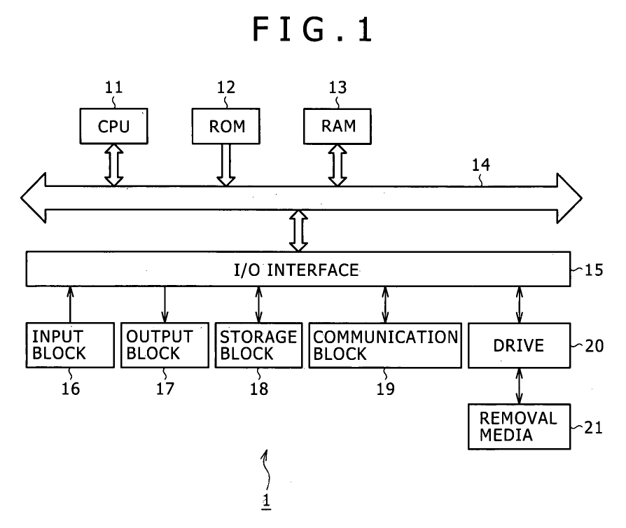

FIG. 1 is a block diagram showing an example of a configuration of a display control apparatus to which the present invention is applied.

A central processing unit (CPU) 11 executes various kinds of processing in accordance with a program stored in a read only memory (ROM) 12, or a program loaded from a storage block 18 into a random access memory (RAM) 13. Data required for the CPU 11 to execute the various kinds of processing is suitably stored in the RAM 13.

The CPU 11, the ROM 12, and the RAM 13 are connected to one another through a bus 14. An I/O interface 15 is also connected to the bus 14.

An input block 16 including a keyboard, a mouse, a light receiving block for receiving infrared light from a remote controller (not shown), or the like, an output block 17 including a liquid crystal display (LCD) or the like, the storage block 18 constituted by a hard disk or the like, and a communication block 19 for performing communication processing through a network are connected to the I/O interface 15.

A drive 20 is also connected to the I/O interface 15 if necessary. A removal medium 21 including a magnetic disk, an optical disk, a magneto-optic disk, a semiconductor memory, or the like is suitably installed in the I/O interface 15. A computer program read out from the removal medium 21 is installed in the storage block 18 as necessary.

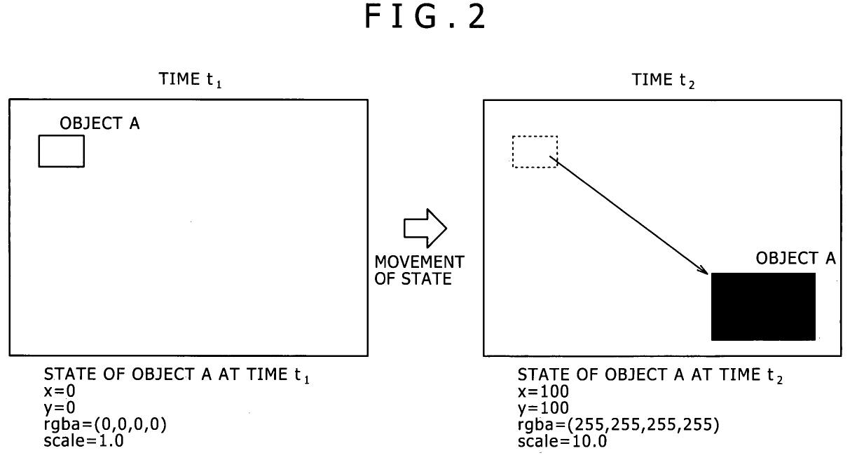

An animation as shown in FIG. 2 for example is made in the display control apparatus 1 having such a configuration.

FIG. 2 is a diagram showing an example of a picture (on the left-hand side of FIG. 2) at a time t1 and a picture (on the right-hand side of FIG. 2) at a time t2 which are displayed on the output block 17. In this case, a description will be given with respect to the movement of a display state of a rectangular object A (an object A).

At the time t1, a position of the object A on the picture A is expressed by x=0 and y=0, and each of values of rgba (red, green, blue, a value α (transmittance)) is expressed by zero. In addition, a size of the object A is expressed by 1.0.

When in this state, the display state of the object A is intended to be moved to a display state at the time t2 in which for example, the position of the object A on the picture is expressed by x=100 and y=100, each of the values of rgba is expressed by 255, and the size of the object A is expressed by 10.0 (when the picture display is intended to be changed), firstly, x=100 and y=100, rgba=(255, 255, 255, 255), and scale=10.0 are set as attribute values representing a display state as a final movement target (hereinafter referred to as “a first state”) in the display control apparatus 1.

In addition, after the attribute values in the final state are set in such a manner, differences between the attribute values in the final state and the attribute values in a current display state (hereinafter referred to as “a current state”) are obtained. Then, the display state is updated so that the differences are gradually reduced every lapse of unit time with a predetermined period.

For example, when the movement of the display state is made from the state at the time t1 to the state at the time t2 in FIG. 2 for 10 unit times, the individual display states are assumed to be updated at equal time intervals. Then, for the attribute values per unit time, the attribute value x is updated by (100−0)/10=10, that is, by 10, and the attribute value y is updated by (100−0)/10=10, that is, by 10. Also, each of the values of the attributes rgba is updated by (255−0)/10=25.5, that is, by 25.5 (actually, integer by integer), and the attribute value scale is updated by (10.0−1.0)/10=0.9, that is, by 0.9.

Consequently, the display state of the object A after a lapse of one unit time from the time t1, for example, is expressed by x=10, y=10, rgba=(26, 26, 26, 26), and scale=0.9. Also, the display state of the object A after a lapse of two unit times from the time t1, for example, is expressed by x=20, y=20, rgba=(52, 52, 52, 52), and scale=1.8. Hereinafter, similarly, the display state of the object A is updated so that the differences between the attribute values in the final state and the attribute values in the current state are gradually reduced every lapse of unit time.

That is, when the attribute value of the object in the current state is expressed by Vt, the attribute value of the object in the final state is expressed by Vg, and the attribute value of the object after the display state is updated once is expressed by Vt+1, the attribute value Vt+1 is expressed by the following expression:
Vt+1=Vt+k(Vg−Vt)

where a coefficient k is a given value equal to or larger than 0, but smaller than 1. Thus, in case of the above-mentioned example, the value of the coefficient k becomes 1/10=0.1 (“10” is the number of unit times until the final state is reached).

At that, the value of the coefficient k can be kept at a fixed value until the final state is reached. However, it is also possible to realize the display like so-called first-in slow-out in which the value of the coefficient k is changed every update of the display state, whereby for example, right after start of the movement of the display state, the interval for each one update (differences between the attribute values before the update and the attribute values after the update) is set as wide, and the interval for each one time update becomes narrower as the display state is nearer the final state. In this case, right after start of the movement of the display state, a relatively large value is set to the coefficient k, and a smaller value is set to the coefficient k as the display state is nearer the final state.

As described above, in the display control apparatus 1, in order to move the display state of a certain object, there are not performed the calculation for obtaining the display states (animations) until the final state of the object for the movement of the display state is reached, and the calculation for generating the interpolation display states for realizing the smooth movement. But, the differences between the attribute values in the current state and the attribute values in the final state are merely gradually reduced with the predetermined period. As a result, the calculation cost can be reduced as compared with the case where such various calculations are required. In addition, the mounting cost can also be reduced since the movement of the display state is expressed by the simple expression as described above.

Such movement of the display state is especially effective in such movement of the display state which is not accompanied by the complicated change in configuration when attention is paid to one object and in which for example, the cursor is moved, or all a predetermined number of icons which are displayed side by side are collectively moved while their colors are changed.

An operation of the display control apparatus will be described later with reference to flow charts.

FIG. 3 is a bock diagram showing an example of a functional configuration of the display control apparatus 1. At least a part of the configuration of FIG. 3 is realized by executing a predetermined program by the CPU 11 shown in FIG. 1.

An application 31 monitors an input through the input block 16 and determines whether or not an event in which the display state of the object being displayed on the output block 17 needs to be moved is generated in accordance with the user's operation. When determining that such an event is generated, the application 31 determines the final state of the object complying with the user's operation, and requests an animation driving block 32 to register the final state.

For example, when in a state in which the cursor is displayed on one of a plurality of icons displayed side by side, the user's operation is performed so as to move the icon to the icon next to the one icon, the application 31 determines that an event is generated, and determines the state in which the cursor is displayed on the icon next to the one icon as the final state of the cursor.

In response to the request from the application 31 to register the final state, an animation driving block 32 requests a final state holding block 33 to generate and register a final state holder. Here, the final state holder serves to hold the final state of the object and to be registered in a list by the final state holding block 33.

In addition, when the final state holder is generated to be registered in the list by the final state holding block 33, the application 31 requests the final state holding block 33 to set the attribute values representing the final state in the final state holder.

When being requested to register the final state by the application 31, the animation driving block 32 requests the final state holding block 33 to generate and register the final state holder. In addition, whenever the request to update the display state of the object is supplied from a timer 34, the animation driving block 32 requests the final state holding block 33 to update the display state.

The final state holding block 33 includes a holding block 41, an update amount calculating block 42, and a state update requesting block 43.

The holding block 41 holds the final state set by the application 31 using the final state holder.

FIG. 4 is a diagram representing the final states held by the holding block 41 in the form of a list.

In response to the request from the animation driving block 32 to generate and register the final state holder, the holding block 41 generates one final state holder to register the resulting one final state holder in the list. The attribute values representing the final state set by the application 31 are set in the final state holders, respectively.

In an example shown in FIG. 4, with respect to moving objects 1 to N as the objects for the movement of the display state, respective final states 1 to N as the final states are registered in the list. In addition, the attribute values (the values within []) representing the respective final states are also registered in the list.

The holding block 41, for example, serves to hold and manage the final states of the respective movement objects using such a list. When the display state of a certain movement object is moved to the registered final state, the holding block 41 releases and cancels the registration of the final state of the certain movement object from the list.

When being requested from the animation driving block 32 to update the display state, the update amount calculating block 42 obtains differences in individual movement objects between the final states held in the holding block 41 and the current states, and calculates an update amount of display state to be updated (an amount required up to such a next display state as to approach from the current states to the final states) from the resulting differences in accordance with the present request to update the display state (at the present update timing). The state update requesting block 43 is informed of the update amount calculated by the update amount calculating block 42. The calculation of the update amount by the update amount calculating block 42, for example, is performed on the basis of the above-mentioned expression.

The state update requesting block 43 requests a GUI component 35 to update the display state of the movement object from the current state to the next display state by the update amount calculated by the update amount calculating block 42.

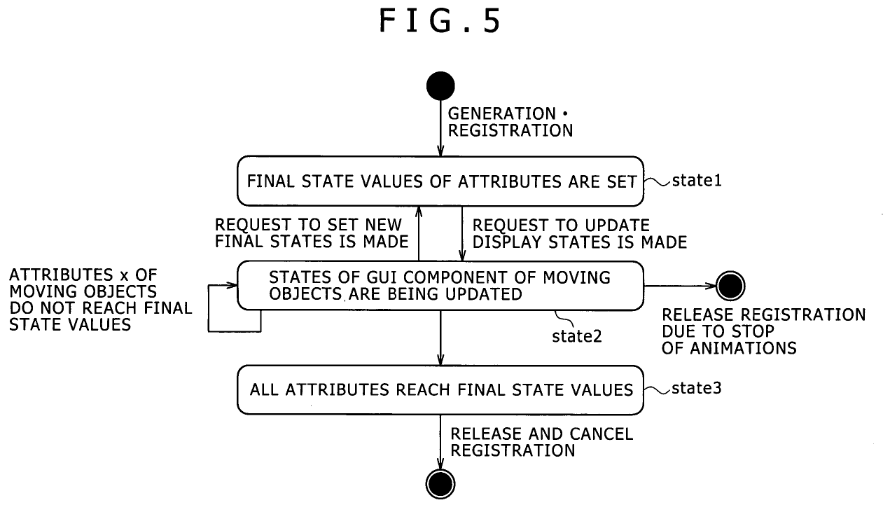

FIG. 5 is a diagram showing an example of the state movement made by the final state holding block 33 including the holding block 41, the update amount calculating block 42, and the state update requesting block 43.

When the final state holder is generated to be registered in the list in accordance with the request made by the animation driving block 32, the final state values of the attributes (the attribute values representing the final state) are set in the final state holding block 33 (the holding block 41) in correspondence to the setting by the application 31 (state 1).

When the request to update the display state is made by the animation driving block 32 in state 1, the operation becomes a state in which the display state of the movement object is being updated (state 2). Basically, this state is maintained until the attribute values reach the final state values.

In state 2, the update of the display state is repeated whenever the request to update the display state is made. In addition, when the request to set the new final state is made before the attribute values reach the final state values, the state of the final state holding block 33 returns back to state 1, and the attribute values in the newly requested final state are set.

When the request to set the final states is newly made before the attribute values reach the final state values, the update of the display state with the final state set until that time as a target is completed, and from this time on, the update of the display state with the newly set final state as a target is started.

From this, even in a case where the update of the display state is started once in order to obtain the final state, when thereafter, a user performs another operation so that when there occurs the necessity of updating the display state of the movement objects with the display state different from the display state until that time as a target, the display state of the movement objects with the newly set display state as a target will be updated.

For example, when in a state in which a cursor is displayed on a first icon of a plurality of icons arranged, a button for moving the cursor to the right-hand side is operated only once while because of only one operation of a button for moving the cursor to the left-hand side, the display state is updated so that the cursor is displayed on a second icon on the left relative to the first icon, the update of the display state is performed so that the movement of the cursor from the first icon to the second icon is completed at a time point when the button for moving the cursor to the right-hand side is operated, and then the cursor is displayed on the first icon in accordance with the user's operation made later.

As a result, the operation feeling can be prevented from being impaired due to occurrence of a time difference between the user's operation and the display of the cursor corresponding thereto.

When a request to stop the update of the display state is made in state 2 in which the display state is updated in such a manner, the registration of the final state is released to be canceled from the list. When all the attribute values reach the final state values, respectively, the display state of the final state holding block 33 is moved from state 2 to state 3. Thereafter, the registration of the final state is released to be canceled from the list.

Referring back to FIG. 3, the timer 34 outputs the request to update the display state to the animation driving block 32 with a predetermined period. It should be noted that any element may also be provided instead of the timer 34 for supplying the request to update the display state as long as it is an element for giving the animation driving block 32 a signal acting as a trigger for the update of the display state with a predetermined period.

The GUI component 35 requests a rendering system 36 to draw the moving object so as to obtain the display state updated by a predetermined update amount in accordance with the request made by the state update requesting block 43.

The rendering system 36 draws the moving objects in accordance with the request made by the GUI component 35.

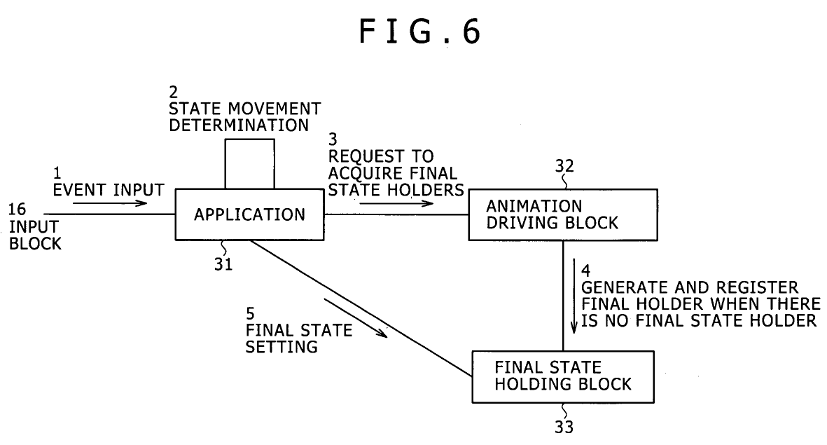

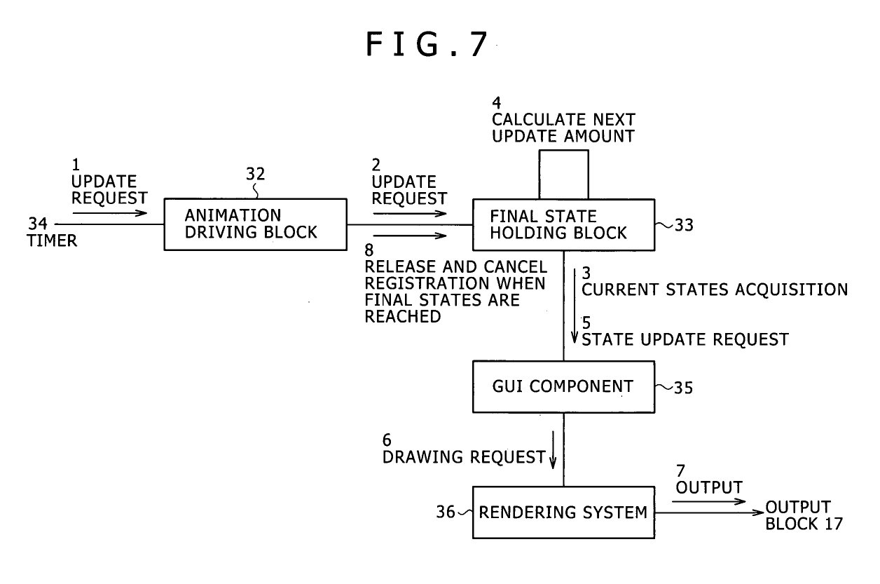

FIGS. 6 and 7 are respectively diagrams showing examples of flows of signals among the blocks of FIG. 3, and processing executed by the blocks. FIG. 6 shows the example of the flow and the processing until the final state is set after an event is generated, and FIG. 7 shows the example of the flow and the processing until the drawing is actually performed after the final state is set.

Referring to FIG. 6, when an event is inputted through the input block 16 (indicated by an arrow 1), the application 31 determines the final state (a loop 2), and requests the animation driving block 32 to register the final state, i.e., to acquire the final state holder (indicated by an arrow 3).

When being requested from the application 31 to register the final state, the animation driving block 32 requests the final state holding block 33 to generate and register that final state holder in the list (indicated by an arrow 4).

When the final state holder is generated by the final state holding block 33 to be registered in the list, the application 31 sets the attribute values representing the final state in the final state holder (indicated by an arrow 5).

The final state is set through the flow of the signals among the blocks and the processing executed by the blocks.

On the other hand, referring to FIG. 7, the animation driving block 32 requests the final state holding block 33 to update the display state (indicated by an arrow 2) in accordance with a request to update the display state which is supplied from the timer 34 with a predetermined period (indicated by an arrow 1).

When being requested to update the display state from the animation driving block 32, the update amount calculating block 42 of the final state holding block 33 makes an inquiry to the GUI component 35, thereby acquiring the current states of the moving objects the display states of which are required to be updated (indicated by an arrow 3).

In addition, the update amount calculating block 42 obtains a difference between the acquired current state and the final state held in the holding block 41 and calculates a present update amount from the resulting difference (a loop 4).

The state update requiring block 43 requests the GUI component 35 to update the display state of the moving object from the current state to a next display state by an update amount calculated by the update amount calculating block 42 (indicated by. an arrow 5).

The GUI component 35 requests the rendering system 36 to draw the moving object so as to obtain the display state through the update by a predetermined amount in accordance with the request made by the state update requesting block 43 (indicated by an arrow 6). The rendering system 36 draws the moving object in accordance with that request (indicated by an arrow 7).

Next, an operation of the display control apparatus 1 will be described with reference to flow charts.

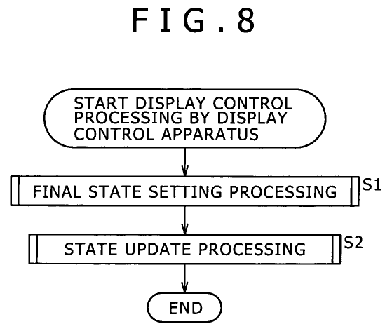

Firstly, display control processing executed by the display control apparatus 1 will be described with reference to a flow chart shown in FIG. 8.

In step S1, final state setting processing is executed. As a result, the final state of the moving object is set in the final state holding block 33. The details of the final state setting processing will be described later with reference to a flow chart shown in FIG. 9. That processing is basically the same as that which was described with reference to FIG. 6.

After the final state is set, state update processing is executed in step S2. As a result, whenever the state update request is made from the timer 34, the display state of the moving object is updated so as to gradually reduce the difference between the current state and the final state. For example, when the display state of the moving object reaches the final state, the state update processing is completed, and the display control processing shown in FIG. 8 is completed.

The details of the state update processing executed in step S2 will be described later with reference to a flow chart shown in FIG. 10. This processing is basically the same as that which was described with reference to FIG. 7.

Here, the final state setting processing executed in step S1 of FIG. 8 will be described with reference to a flow chart shown in FIG. 9.

In step S11, the application 31 determines whether or not an event has been inputted thereto through the input block 16. If not, the application 31 waits until it determines that the event has been inputted.

When the application 31 determines in step S11 that the event has been inputted, the operation proceeds to step S12, and the application 31 determines the final state of the moving object.

In step S13, the application 31 requests the animation driving block 32 to acquire the final state holder for setting the final state. The animation driving block 32 which has received that request requests the final state holding block 33 to generate and register the final state holder in the list.

In step S14, the holding block 41 of the final state holding block 33 determines whether or not the final state holder of the final state being currently selected (the final state of the moving object the display state of which is required to be updated in correspondence to generation of the event) is previously registered in the list. If not, the operation proceeds to step S15.

In step S15, the holding block 41 generates the final state holder and registers the resulting final state holder in the list.

In step S16, the application 31 sets the attribute values representing the final state in the final state holder.

After the attribute values representing the final state are set, or when it is determined in step S14 that the final state holder is previously registered in the list, the operation proceeds to step S2 shown in FIG. 8.

Next, the state updating processing executed in step S2 shown in FIG. 8 will be described with reference to a flow chart shown in FIG. 10.

In step S31, the animation driving block 32 determines whether or not a request to update the display state has been made from the timer 34. If not, the animation driving block 32 waits until it determines that the update request has been made.

When the animation driving block 32 determines in step S31 that the update request has been made, the operation proceeds to step S32, and the animation driving block 32 requests the final state holding block 33 to update the display state.

In step S33, the update amount calculating block 42 of the final state holding block 33 makes an inquiry to the GUI component 35, thereby acquiring the current states of the individual moving objects. Then, the operation proceeds to step S34. In step S34, the update amount calculating block 42 obtains differences between the current states acquired in step S33 and the final states held in the holding block 41, and calculates the present update amount from the resulting differences. The update amount calculating block 42 informs the state update requesting block 43 of the calculated update amount.

In step S35, the state update requesting block 43 requests the GUI component 35 to update the display state of the moving object from the current state to a next display state by an update amount calculated by the update amount calculating block 42.

In step S36, the GUI component 35 requests the rendering system 36 to draw the moving object so as to obtain the display state through the update by a predetermined update amount.

In step S37, the rendering system 36 draws the moving object in accordance with the request made by the GUI component 35.

In step S38, the state update requesting block 43 determines whether or not the display state of the moving object has reached the final states. If not, the operation proceeds to step S31. Then, the processing in and after the processing in step S31 is repeatedly executed. That is, the display states of the moving object are successively updated so as to approach the final state in correspondence to the supply of the next state update request from the timer 34 to the animation driving block 32.

On the other hand, when the state update requesting block 43 determines in step S38 that the display state of the moving object has reached the final state, the operation proceeds to step S39. Then, the state update requesting block 43 requests the holding block 41 to release and cancel the registration of the final state holder holding the final state from the list. Thereafter, the operation returns back to step S2 shown in FIG. 8, and the display control processing shown in FIG. 8 is completed.

The display states of the individual moving objects have reached the final states, respectively, and the display according to the user's operation is realized through the above-mentioned processing.

While the description has been mainly given with respect to the case where the present invention was applied to the cursor display so far, as a matter of course, the present invention can also be applied to the display of the various objects other than the displayed cursor.

In addition, in the above-mentioned case, the display states such as the final states are represented by the attribute values such as the positions, the colors, and the sizes. However, in addition thereto, when the display state of the object is updated while being rotated, the display state may also be represented by the attribute value of the angle rotation. Alternatively, the display state may also be represented by other various attribute values other than the attribute value of the angle of rotation.

It should be noted that in the specification, steps include the processing which is executed in a time series manner in the described order, and also include the processing which is executed in a parallel manner or individually even if being executed not in a time series manner.

What is claimed is:

1. A display control apparatus for updating a display state of an object for movement with a predetermined period, comprising:
setting means for setting a final state as a final target display state of said object;
calculation means for calculating an update amount of display state at next update timing from a different between the final state set by said setting means and a current state as a current display state of said object; and
update means for updating the display state of said object based on the update amount of display state calculated by said calculation means.

2. The display control apparatus according to claim 1, wherein said setting means sets the display state displayed based on at least any one of a position, a color, an angle of rotation, and a size as the final state.

3. The display control apparatus according to claim 1, wherein said setting means set the final state on each object becoming an update object of the display state in accordance with an operation by a user.

4. The display control apparatus according to claim 1,
wherein when an operation by a user for setting another final state as a target is performed after said update means starts the update of the display state of said object, said setting means sets the another final state as a display state as a new target of said object in accordance with the operation by the user, and
said calculation means calculates an update amount from a difference between a current state and the another final state with the display state of said object when the user's operation is performed as the current state.

5. The display control apparatus according to claim 1, further comprising determination means for determining whether or not the final state is previously set (registered) when said setting means sets the final state,
wherein where said determination means determines that the final state is previously set, said calculation means calculates an update amount of display state at next update timing from a difference between the previously set final state and a current state as a current display state of said object.

6. A display control method for use in a display control apparatus for updating a display state of an object for movement with a predetermined period, comprising the steps of:
setting a final state as a final target display state of said object;
calculating an update amount of display state at next update timing from a different between the final state set through the processing in the setting step and a current state as a current display state of the object; and
updating the display state of said object based on the update amount of display state calculated through the processing in the calculation step.

7. A program for instructing a computer to execute a processing for updating a display state of an object for movement with a predetermined period, comprising the steps of:
setting a final state as a final target display state of said object;
calculating an update amount of display state at next update timing from a different between the final state set through the processing in the setting step and a current state as a current display state of the object; and
updating the display state of said object based on the update amount of display state calculated through the processing in the calculation step.

8. A display control apparatus for updating a display state of an object for movement with a predetermined period, comprising:
a setting unit for setting a final state as a final target display state of said object;
a calculation unit for calculating an update amount of display state at next update timing from a different between the final state set by said setting unit and a current state as a current display state of said object; and
an update unit for updating the display state of said object based on the update amount of display state calculated by said calculation unit.
